(19) United States
(12) Patent Application Publication
(10) Pub. No.: US 2019/0337844 A1
(43) Pub. Date: Nov. 7, 2019

(54) METHOD FOR PRODUCING CHEMICALLY STRENGTHENED GLASS

(71) Applicant: AGC INC, Chiyoda-ku (JP)

(72) Inventors: Yoshiteru IKEDA, Tokyo (JP); lzuru KASHIMA, Tokyo (JP); Hiroki TAKAHASHI, Tokyo (JP); Kaname SEKIYA, Tokyo (JP)

(73) Assignee: AGC INC., Chiyoda-ku (JP)

(21) Appl. No.: 16/394,040

(22) Filed: Apr. 25, 2019

(30) Foreign Application Priority Data
May 1, 2018 (JP) 2018-088231
Aug. 29, 2018 (JP) 2018-160835

(51) Int. Cl. C03C 21/00

(52) U.S. Cl. CPC C03C 21/002; C03C 15/00

(57) ABSTRACT

The present invention relates to a method for producing a chemically strengthened glass, the method including the following steps (1) to (3) in this order: (1) a glass sheet preparation step of preparing a glass sheet having, in a surface layer thereof, a compressive stress layer; (2) a first ion exchange step of bringing the glass sheet into contact with an inorganic salt composition to perform ion exchange of at least one pair of ions so as to decrease a compressive stress value of the compressive stress layer; and (3) a second ion exchange step of bringing the glass sheet into contact with an inorganic salt composition to perform ion exchange of at least one pair of ions so as to increase the compressive stress value of the compressive stress layer in the surface layer.

### FIELD OF THE INVENTION

The present invention relates to a method for producing a chemically strengthened glass.

### BACKGROUND OF THE INVENTION

A chemically strengthened glass obtained by forming a compressive stress layer on a glass surface through chemical strengthening such as ion exchange is thin, nevertheless, resistant to cracking, etc. and therefore, has been heretofore used as a cover glass for a display of various information terminal devices, etc.

Since the chemically strengthened glass has a compressive stress layer on its surface, if something not satisfying the desired specification after chemical strengthening, for example, external damage (pits or scratches) or warpage at a level falling below the standard, is generated, these are difficult to repair, and the glass may be forced to be discarded.

Conventionally, as the method for removing the compressive stress layer of a chemically strengthened glass and again forming a chemically strengthened layer, Patent Document 1 discloses a method in which the compressive stress layer is removed in part or in whole by the etching or polishing of the main surface of a chemically strengthened glass and then a compressive stress layer is incorporated by a chemical strengthening process.

Patent Document 1 does not disclose regeneration (recycling) of a chemically strengthened glass but in terms of again forming a compressive stress layer after removal of a compressive stress layer, readjustment of a compressive stress layer is possible.

### SUMMARY OF THE INVENTION

However, in Patent Document 1, the compressive stress layer on a chemically strengthened glass surface is removed by etching or polishing, and the level of decrease in the compressive stress value of the compressive stress layer is insufficient, leaving a problem, for example, that when a chemical strengthening treatment is again performed, the product exceeds the size standards thereof due to expansion of the glass.

In addition, when the compressive stress layer is intended to be completely removed by polishing, the glass thickness decreases and therefore, there is also a problem, for example, that the predetermined standards for product sheet thickness are not satisfied.

An object of the present invention is to provide a method for producing a chemically strengthened glass which has a predetermined compressive stress value by virtue of re-forming a compressive stress layer on a chemically strengthened glass surface and is recycled as a high-quality chemically strengthened glass.

The method for producing a chemically strengthened glass of the present invention includes a step of bringing a glass sheet having, in a surface layer thereof, a compressive stress layer into contact with an inorganic salt composition so as to decrease the compressive stress value of the compressive stress layer through ion exchange, and then bringing the glass sheet into contact with an inorganic salt composition so as to increase the compressive stress value of the compressive stress layer in the surface layer through ion exchange, whereby recycling of a chemically strengthened glass can be realized with high quality.

Namely, the present invention provides the following configurations.

[1] A method for producing a chemically strengthened glass, the method including the following steps (1) to (3) in this order:
(1) a glass sheet preparation step of preparing a glass sheet having, in a surface layer thereof, a compressive stress layer;
(2) a first ion exchange step of bringing the glass sheet into contact with an inorganic salt composition to perform ion exchange of at least one pair of ions so as to decrease a compressive stress value of the compressive stress layer; and
(3) a second ion exchange step of bringing the glass sheet into contact with an inorganic salt composition to perform ion exchange of at least one pair of ions so as to increase the compressive stress value of the compressive stress layer in the surface layer.

[2] The method for producing a chemically strengthened glass according to [1], further including, between the first ion exchange step and the second ion exchange step, a polishing step of polishing a surface of the glass sheet.

[3] The method for producing a chemically strengthened glass according to [2], in which, in the polishing step, the surface of the glass sheet is polished by 1 μm or more.

[4] The method for producing a chemically strengthened glass according to [3], in which, in the polishing step, two main surfaces of the glass sheet opposing each other in a thickness direction are polished by the same removal amount.

[5] The method for producing a chemically strengthened glass according to [1], further including, between the first ion exchange step and the second ion exchange step, an etching step of etching the surface of the glass sheet with a chemical solution containing hydrofluoric acid.

[6] The method for producing a chemically strengthened glass according to any one of [1] to [5], in which a combination of ions in the pair of ions in the first ion exchange step is the same as a combination of ions in the pair of ions in the second ion exchange step.

[7] The method for producing a chemically strengthened glass according to [6], in which the combination of ions in the pair of ions is a combination of K ion and Na ion.

[8] The method for producing a chemically strengthened glass according to [7], in which, in the first ion exchange step, the glass sheet is brought into contact with an inorganic salt composition containing 50 mass % or more of NaNO₃.

[9] The method for producing a chemically strengthened glass according to [7] or [8], in which, in the second ion exchange step, the glass sheet is brought into contact with an inorganic salt composition containing 75 mass % or more of KNO₃.

[10] The method for producing a chemically strengthened glass according to any one of [1] to [9], in which ion exchange of two pairs of ions is performed in the first ion exchange step, and ion exchange of two pairs of ions is performed in the second ion exchange step.

[11] The method for producing a chemically strengthened glass according to [10], in which combinations of ions in the two pairs of ions in the first ion exchange step is the same as combinations of ions in the two pairs of ions in the second ion exchange step.

[12] The method for producing a chemically strengthened glass according to [11], in which the combinations of ions in the two pairs of ions are a combination of K ion and Na ion and a combination of Na ion and Li ion.

[13] The method for producing a chemically strengthened glass according to [12], in which, in the first ion exchange step, the glass sheet is brought into contact with an inorganic salt composition containing 5 mass % or more of LiNO₃ and 50 mass % or more of NaNO₃.

[14] The method for producing a chemically strengthened glass according to [12], in which, in the first ion exchange step, the glass sheet is brought into contact with an inorganic salt composition containing 5 mass % or more of LiNO₃, 40 mass % or more of NaNO₃, and from 3 to 30 mass % of KNO₃.

[15] The method for producing a chemically strengthened glass according to any one of [12] to [14], in which, in the second ion exchange step, the glass sheet is brought into contact with an inorganic salt composition containing 55 mass % or more of NaNO₃, and then brought into contact with an inorganic salt composition containing 75 mass % or more of KNO₃.

[16] The method for producing a chemically strengthened glass according to any one of [1] to [15], in which the compressive stress value in the surface of the glass sheet is decreased to 100 MPa or less by the first ion exchange step.

[17] The method for producing a chemically strengthened glass according to any one of [1] to [16], in which the glass sheet includes a curved part having a radius of curvature of 100 mm or less in at least a part of the glass sheet.

According to the production method of a chemically strengthened glass of the present invention, after a compressive stress value of a compressive stress layer of a glass sheet having the compressive stress layer in the surface layer thereof is effectively decreased through ion exchange, the compressive stress value of the compressive stress layer is increased through ion exchange to obtain a predetermined compressive stress value and at the same time, expansion of the glass, reduction in strength, etc. are suppressed, so that recycling as a high-quality chemically strengthened glass can be realized.

### DETAILED DESCRIPTION OF THE INVENTION

The present invention is described in detail below, but the present invention is not limited to the following embodiments and can be implemented by making any modification within the scope not deviating from the gist of the present invention.

In the present description, a numerical range indicated using “to” is used in the sense of including the numerical values described before and after it as a lower limit value and an upper limit value. In addition, in the present description, unless otherwise indicated, the composition (content of each component) of the glass is described by expressing it in terms of mole percent based on oxides.

The method for producing a chemically strengthened glass according to one embodiment of the present invention (hereinafter, sometimes simply referred to as the present production method) is described below.

The present production method includes the following steps (1) to (3) in this order:
(1) a glass sheet preparation step of preparing a glass sheet having, in a surface layer thereof, a compressive stress layer;
(2) a first ion exchange step of bringing the glass sheet into contact with an inorganic salt composition to perform ion exchange of at least one pair of ions so as to decrease a compressive stress value of the compressive stress layer; and
(3) a second ion exchange step of bringing the glass sheet into contact with an inorganic salt composition to perform ion exchange of at least one pair of ions so as to increase the compressive stress value of the compressive stress layer in the surface layer.

Each step is described below.

### <Step (1)>

Step (1) is a step of preparing a glass sheet having, in the surface layer thereof, a compressive stress layer. The composition of the glass sheet may be sufficient if it is a composition capable of molding and strengthening by chemical strengthening treatment. Examples of the glass sheet include aluminosilicate glass, soda lime glass, borosilicate glass, lead glass, alkali barium glass, and aluminoborosilicate glass.

As the composition of the glass sheet, for example, the following composition may be mentioned.

Glass including, in terms of mole percent based on oxides, from 50 to 80% of SiO₂, from 2 to 25% of Al₂O₃, from 0.1 to 20% of Li₂O, from 0.1 to 18% of Na₂O, from 0 to 10% of K₂O, from 0 to 15% of MgO, from 0 to 5% of CaO, from 0 to 5% of P₂O₅, from 0 to 5% of B₂O₃, from 0 to 5% of Y₂O₃, and from 0 to 5% of ZrO₂.

The glass sheet can be produced, for example, by charging predetermined glass raw materials into a continuous melting furnace, heating and melting the glass raw materials at 1,500 to 1,600° C., refining the melt, feeding it to a forming apparatus, and forming the molten glass into a sheet shape, followed by annealing. Examples of the method for forming a glass sheet include a downdraw process (for example, an overflow downdraw process, a slot down process and a redraw process), a float process, a rollout process, and a pressing process.

The thickness of the glass sheet varies depending on the specification of the cover glass and is not particularly limited but in order to effectively perform the chemical strengthening treatment, the thickness thereof is preferably 5 mm or less, more preferably 3 mm or less, still more preferably 1 mm or less, yet still more preferably 0.85 mm or less. The lower limit of the thickness of the glass sheet is not particularly limited but may be 0.1 mm or more and is preferably 0.2 mm or more, more preferably 0.3 mm or more. In addition, examples of the glass sheet include a flat-shaped glass sheet having a uniform thickness and a three-dimensionally shaped glass sheet having a curved part, a bend part, etc. in at least a part of the glass sheet, such as 2.5D cover glass or 3D cover glass represented by the glass for smartphone. Incidentally, the above-described preferable range for the thickness of the glass sheet is also applicable as a preferable range for the thickness of a chemically strengthened glass sheet.

In the case of, among others, such a three-dimensionally shaped glass, the present production method is likely to exert the effect of suppressing expansion, etc. of glass and regenerating a chemically strengthened glass with high quality. As the three-dimensionally shaped glass sheet, for example, a glass sheet having a curved part having a radius of curvature of 100 mm or less in at least a part of the glass sheet may be mentioned. Specifically, examples thereof include a three-dimensionally shaped glass sheet in which, in a glass sheet having a rectangular shape in plan view, two opposing sides form a curved shape, and a three-dimensionally shaped glass sheet in which, in the rectangular glass sheet above, the peripheries including four corners form a curved shape.

The chemical strengthening treatment for forming a compressive stress layer in a surface layer of a glass sheet is a treatment of bringing a glass sheet into contact with an inorganic salt composition, thereby replacing a metal ion in the glass by a metal ion having a larger ionic radius than the metal ion, which is present in the inorganic salt composition.

Examples of the method for bringing a glass sheet into contact with an inorganic salt composition include a method of applying a paste-like inorganic salt composition onto a glass sheet, a method of spraying an aqueous solution of an inorganic salt composition on a glass sheet, and a method of immersing a glass sheet in a salt bath of a molten salt of an inorganic salt composition heated at a temperature not lower than the melting point. Among these, from the viewpoint of enhancing the productivity, a method of immersing a glass sheet in a molten salt of an inorganic salt composition is preferred.

The chemical strengthening treatment by the method of immersing a glass sheet in a molten salt of an inorganic salt composition can be conducted, for example, by the following procedure. First, a glass sheet is preheated at 100° C. or more, and the molten salt is adjusted to a temperature at which chemical strengthening is performed. Next, the preheated glass sheet is immersed in the molten salt for a predetermined period of time and thereafter, the glass sheet is drawn up from the molten salt and allowed to cool.

In the compressive stress layer formed in the surface layer of the chemically strengthened glass sheet, the compressive stress value (CS) at the outermost surface is not particularly limited but, usually, is preferably 500 MPa or more, more preferably 600 MPa or more, still more preferably 700 MPa or more.

The compressive stress value and compressive stress layer depth of the compressive stress layer of the chemically strengthened glass sheet can be measured by a surface stress meter (for example, FSM-6000 manufactured by Orihara Manufacturing Co., Ltd.) and a light-scattering photoelastic stress meter (for example, SLP-1000 manufactured by Orihara Manufacturing Co., Ltd.).

As the chemically strengthened glass sheet having, in the surface layer thereof, a compressive stress layer, for example, a glass sheet having an external damage (e.g., pits and scratches) which does not satisfy the desired specification may be mentioned.

Examples of the chemically strengthened glass sheet having an external damage which does not satisfy the desired specification include a chemically strengthened glass sheet in which a visually recognizable appearance defect such as damage is present when the appearance of glass is observed by setting the distance between the glass and an eye of the judge to be 50 cm under illumination with an illuminance of 5,000 lux in a dark-room environment. In addition, examples of the damage working out to a visually recognizable defect include a scratch having a width of 0.1 mm in the environment described above, and a scratch having a width of 0.05 mm to 0.1 mm and a length of 1 mm or more.

### <Step (2)>

The step (2) is a first ion exchange step of bringing a chemically strengthened glass sheet having, in the surface layer thereof, a compressive stress layer into contact with an inorganic salt composition to perform ion exchange of at least one pair of ions so as to decrease the compressive stress value of the compressive stress layer.

In the first ion exchange step, a compressive stress value of the compressive stress layer is decreased through ion exchange between an ion in the glass and an ion having a smaller ionic radius than the ion described above.

The combination of ions to be exchanged in the first ion exchange step may be at least one pair and may be two or more pairs. Examples of the combination of ions to be exchanged include the followings:
K ion in the glass and Na ion in the inorganic salt composition; and
Na ion in the glass and Li ion in the inorganic salt composition.

For example, in the case of performing ion exchange of two pairs of ions, examples of the combinations of ions include the following combinations:
a combination of K ion in the glass and Na ion in the inorganic salt composition, and a combination of Na ion in the glass and Li ion in the inorganic salt composition.

Examples of the salt contained in the inorganic salt composition used in the first ion exchange step include sodium nitrate, sodium carbonate, sodium chloride, sodium borate, sodium sulfate, potassium nitrate, potassium carbonate, potassium chloride, potassium borate, potassium sulfate, lithium nitrate, lithium carbonate, lithium chloride, lithium borate, and lithium sulfate, and one of these may added alone, or a plurality thereof may be added in combination.

The kind and content of the salt contained in the inorganic salt composition used in the first ion exchange step may be appropriately set so that the compressive stress value by the compressive stress layer can be decreased through ion exchange.

Examples of the kind and content of the salt contained in the inorganic salt composition include the followings.
In the case of ion-exchanging K ion in the glass with Na ion in the inorganic salt composition, use of an inorganic salt composition containing 50 mass % or more of NaNO₃ is preferred.

In addition, use of an inorganic salt composition containing 55 mass % or more of NaNO₃ is more preferred, and use of an inorganic salt composition containing 60 mass % or more of NaNO₃ is still more preferred.
In the case of ion-exchanging a pair of K ion in the glass and Na ion in the inorganic salt composition and a pair of Na ion in the glass and Li ion in the inorganic salt composition, use of an inorganic salt composition containing 5 mass % or more of LiNO₃ and 50 mass % or more of NaNO₃ is preferred.

In addition, use of an inorganic salt composition containing 10 mass % or more of LiNO₃ and 55 mass % or more of NaNO₃ is more preferred, and use of an inorganic salt composition containing 15 mass % or more of LiNO₃ and 60 mass % or more of NaNO₃ is still more preferred.

Furthermore, in the case of ion-exchanging a pair of K ion in the glass and Na ion in the inorganic salt composition and a pair of Na ion in the glass and Li ion in the inorganic salt composition, examples of the kind and content of the salt contained in the inorganic salt composition include the following.
Use of an inorganic salt composition containing 5 mass % or more of LiNO₃, 40 mass % or more of NaNO₃, and from 3 to 30 mass % of KNO₃ is preferred. More specifically, even in the case of ion-exchanging K ion in the glass with Na ion in the inorganic salt composition, it is preferable to incorporate KNO₃ in the ratio described above into the inorganic salt composition, because the compressive stress by K ion is effective in preventing disintegration of the glass composition.

In addition, use of an inorganic salt composition containing 10 mass % or more of LiNO₃, 55 mass % or more of NaNO₃, and from 5 to 18 mass % of KNO₃ is more preferred, and use of an inorganic salt composition containing 15 mass % or more of LiNO₃, 60 mass % or more of NaNO₃, and from 7 to 15 mass % of KNO₃ is still more preferred.

The temperature at which contact between the chemically strengthened glass sheet and the inorganic salt composition in the first ion exchange step is conducted is not particularly limited, but from the viewpoint of expediting the ion exchange rate and enhancing the productivity, the contact temperature is preferably 310° C. or more, more preferably 330° C. or more, still more preferably 350° C. or more. Furthermore, from the viewpoint of reducing volatilization of the salt, the contact temperature is preferably 530° C. or less, more preferably 500° C. or less, still more preferably 450° C. or less.

The time for which contact between the chemically strengthened glass sheet and the inorganic salt composition in the first ion exchange step is conducted is not particularly limited, but from the viewpoint of reducing variation in the ion exchange level due to time fluctuation, the contact time is preferably 1 hour or more, more preferably 3 hours or more, yet still more preferably 5 hours or more. Furthermore, from the viewpoint of enhancing the productivity, the contact time is preferably 72 hours or less.

The compressive stress value of the compressive stress layer, which is decreased in the first ion exchange step, is preferably lower, and it is most preferred that the compressive stress layer is completely removed. For example, the compressive stress value (CS) of the compressive stress layer after the first ion exchange step is, at a depth of 50 μm from the surface, preferably 10 MPa or less, more preferably 7 MPa or less, still more preferably 4 MPa or less, and most preferably 0 MPa. Furthermore, the compressive stress value of the glass surface after the first ion exchange step is preferably 100 MPa or less, more preferably 50 MPa or less, further preferably 20 MPa or less, and particularly preferably 10 MPa or less.

### <Step (3)>

The step (3) is a second ion exchange step of bringing the glass sheet in which the compressive stress value has been decreased in the step (2), into contact with an inorganic salt composition to perform ion exchange of at least one pair of ions so as to increase the compressive stress value of the compressive stress layer formed in a surface layer of the glass sheet to thereby achieve chemical strengthening. Specifically, in the second ion exchange step, a compressive stress value of the compressive stress layer is increased through ion exchange between an ion in the glass and an ion having a larger ionic radius than the ion described above.

The combination of ions to be exchanged in the second ion exchange step may be at least one pair and may be two or more pairs. Examples of the combination of ions to be exchanged include the followings:
Na ion in the glass and K ion in the inorganic salt composition; and
Li ion in the glass and Na ion in the inorganic salt composition.

For example, in the case of performing ion exchange of two pairs of ions, examples of the combinations of ions include the following combinations:

a combination of Na ion in the glass and K ion in the inorganic salt composition, and a combination of Li ion in the glass and Na ion in the inorganic salt composition.

Examples of the salt contained in the inorganic salt composition used in the second ion exchange step include sodium nitrate, sodium carbonate, sodium chloride, sodium borate, sodium sulfate, potassium nitrate, potassium carbonate, potassium chloride, potassium borate, and potassium sulfate, and one of these may added alone, or a plurality thereof may be added in combination.

The kind and content of the salt contained in the inorganic salt composition used in the second ion exchange step may be appropriately set so that the desired compressive stress value and compressive stress layer depth can be obtained.

For example, with respect to the method for ion-exchanging Na ion in the glass with K ion in the inorganic salt composition, as the inorganic salt composition to be brought into contact with the glass sheet, use of an inorganic salt composition containing 75 mass % or more of KNO₃ is preferred. In addition, use of an inorganic salt composition containing 80 mass % or more of KNO₃ is more preferred, and use of an inorganic salt composition containing 85 mass % or more of KNO₃ is still more preferred.

In the case of ion-exchanging two or more pairs of ions in the second ion exchange step, the glass sheet may be chemically strengthened through ion exchange in two or more stages. Examples of the ion exchange in two or more stages include the following.
As the first-stage ion exchange, the glass sheet is brought into contact with an inorganic salt composition containing 55 mass % or more of NaNO₃ to ion-exchange Li ion in the glass with Na ion in the inorganic salt composition, and
after that, as the second-stage ion exchange, the glass sheet is brought into contact with an inorganic salt composition containing 75 mass % or more of KNO₃ to ion-exchange Na ion in the glass with K ion in the inorganic salt composition.

The content of NaNO₃ in the inorganic salt composition at the time of first-stage ion exchange is preferably 60 mass % or more, more preferably 65 mass % or more. In addition, the content of KNO₃ in the inorganic salt composition at the time of second-stage ion exchange is preferably 80 mass % or more, more preferably 85 mass % or more.

The combination of ions to be ion-exchanged may be the same or different between the first ion exchange step [step (2)] and the second ion exchange step [step 3].

Furthermore, the number of combinations of ions to be ion-exchanged may be the same or different between the first ion exchange step and the second ion exchange step.

Examples of the combinations of ions in the first ion exchange step and the second ion exchange step include the followings:
(a) a combination of the same pairs of ions are ion-exchanged in the first ion exchange step and the second ion exchange step;
(b) a combination of different pairs of ions are ion-exchanged in the first ion exchange step and the second ion exchange step;
(c) ion exchange of two pairs of ions is performed in the first ion exchange step and thereafter, ion exchange of the same two pairs of ions as the two pairs of ions described above is performed in the second ion exchange step;
(d) ion exchange of one pair of ions is performed in the first ion exchange step and thereafter, ion exchange of two pairs of ions is performed in the second ion exchange step; and
(e) ion exchange of two pairs of ions is performed in the first ion exchange step and thereafter, ion exchange of one pair of ions is performed in the second ion exchange step.

Examples of the case (a) include a case where K ion in the glass is ion-exchanged with Na ion in the inorganic salt composition in the first ion exchange step, and thereafter, Na ion in the glass is ion-exchanged with K ion in the inorganic salt composition in the second ion exchange step.

Examples of the case (c) include a case where ion exchange of K ion in the glass with Na ion in the inorganic salt composition and ion exchange of Na ion in the glass with Li ion in the inorganic salt composition are performed in the first ion exchange step, and thereafter, ion exchange of Na ion in the glass with K ion in the inorganic salt composition and ion exchange of Li ion in the glass with Na ion in the inorganic salt composition are performed in the second ion exchange step.

The temperature at which contact between the glass sheet and the inorganic salt composition in the second ion exchange step is conducted is not particularly limited, but from the viewpoint of expediting the ion exchange rate and enhancing the productivity, the contact temperature is preferably 310° C. or more, more preferably 330° C. or more, still more preferably 350° C. or more. Furthermore, from the viewpoint of reducing volatilization of the salt, the contact temperature is preferably 530° C. or less, more preferably 500° C. or less, still more preferably 475° C. or less.

The time for which contact between the glass sheet and the inorganic salt composition in the second ion exchange step is conducted is not particularly limited, but from the viewpoint of reducing variation in the ion exchange level due to time fluctuation, the contact time is preferably 30 minutes or more, more preferably 45 minutes or more, yet still more preferably 1 hour or more. Furthermore, from the viewpoint of enhancing the productivity, the contact time is preferably 20 hours or less.

The compressive stress value (CS) of the compressive stress layer formed after the second ion exchange step is not particularly limited but, at a depth of 50 pm from the surface, is preferably 15 MPa or more, more preferably 20 MPa or more, still more preferably 25 MPa or more. In addition, the compressive stress value of the glass surface after the second ion exchange step is also not particularly limited but may be 500 MPa or more and is preferably 600 MPa or more, more preferably 700 MPa or more, still more preferably 800 MPa or more.

### <Polishing Step/Etching Step>

The present production method may include, between the first ion exchange step and the second ion exchange step, a polishing step of polishing the surface of the glass sheet or an etching step of etching the surface of the glass sheet. By polishing or etching the surface of the glass sheet where the compressive stress value has been decreased, microdamage on the surface of the glass sheet is removed, so that the surface strength of the glass sheet after chemical strengthening in the second ion exchange step can be enhanced.

In the polishing step, in view of warpage prevention of the glass sheet, two main surfaces of the glass sheet opposing each other in the thickness direction are preferably polished by the same removal amount. The polishing conditions are not particularly limited, and the polishing can be performed under the conditions providing the desired surface roughness.

The removal amount of the surface of the glass sheet in the polishing step is not particularly limited but is preferably 1 μm or more, more preferably 3 μm or more, still more preferably 5 μm or more. In addition, the removal amount in the polishing step is usually 25 μm or less.

In the polishing step, for example, abrasive grains such as cerium oxide and colloidal silica can be used. The average particle size of the abrasive grains is preferably from 0.02 μm to 2.0 μm, and as the concentration of abrasive grains, the specific gravity when formed into a slurry is preferably from 1.03 to 1.13. The polishing pressure is preferably from 6 kPa to 20 kPa, and the rotational speed of the platen of the polishing apparatus is preferably from 20 m/min to 100 m/min in terms of the circumferential speed of the outermost circumference. The polishing can be conducted, as an example, by a general method where cerium oxide having an average particle size of about 1.2 μm is dispersed in water to make a slurry having a specific gravity of 1.07 and surfaces of a glass sheet is polished by 0.5 μm or more per one surface under the condition of a polishing pressure of 9.8 kPa by using a polishing pad with the surface being nonwoven fabric or suede. In the polishing step, a polishing pad with the surface being nonwoven fabric or suede, which provides a Shore A hardness of 25° to 65° and a sinking amount at 100 g/cm² of 0.05 mm or more, can be applied. Among these, in view of cost, use of a nonwoven fabric polishing pad is preferred.

As for the etching in the etching step, the etching can be performed, for example, with a chemical solution containing hydrofluoric acid. The etching amount in the etching step is not particularly limited but is preferably 1 μm or more, more preferably 3 μm or more, still more preferably 5 μm or more. In addition, the etching amount in the etching step is usually 25 μm or less.

In the chemically strengthened glass produced by the present production method, the expansion ratio of the longitudinal length of the glass sheet after the step (3) relative to the longitudinal length of the glass sheet before the step (3) is preferably 0.20% or less, more preferably 0.17% or less, yet still more preferably 0.15% or less.

The longitudinal length as used herein includes, for example, a longitudinal direction running in parallel to the long-side direction of the glass sheet having a rectangular outer edge in plan view.

The present production method preferably further includes a washing step of washing the glass sheet between respective steps of steps (1) to (3). In the washing step, industrial water, ion-exchanged water, etc. can be used, and among these, use of ion-exchanged water is preferred.

The washing conditions may vary depending on the washing solution but in the case of using ion-exchanged water, the glass sheet is preferably washed at a temperature of 0 to 100° C., because the adhered salts can be completely removed. In the washing step, various methods, such as a method of immersing the glass in a water tank containing ion-exchanged water, etc., a method of exposing the glass surface to running water, and a method of spraying a washing solution from a shower on the glass surface, may be used.

The chemically strengthened glass produced by the present production method has a dimension enabling forming by an existing forming method and may be finally cut into a size suitable for the intended use after the chemical strengthening [after the step (3)], and it is also possible to chemically strengthen a glass sheet that has been cut into a predetermined dimension before chemical strengthening. That is, the chemically strengthened glass can respond to sizes ranging from a display of tablet PC, smartphone, etc. to automotive glass, window glass for buildings or housings, etc. The outer edge of the chemically strengthened glass is not limited to a rectangular shape but may be of a shape such as circular or polygonal, and the chemically strengthened glass may also be a glass subjected to drilling.

### EXAMPLES

### 1. Evaluation Method

Various evaluations in the present Examples were performed according to the analysis methods described below.

### (Surface Stress)

The surface compressive stress value (unit: MPa), the compressive stress value at each depth (CS, CSk, unit: MPa), and the depth of the compressive stress layer (DOL, unit: μm) of a glass were measured using a surface stress meter (FSM-6000) manufactured by Orihara Manufacturing Co., Ltd. and a light-scattering photoelastic stress meter (SLP-1000) manufactured by Orihara Manufacturing Co., Ltd.

### (Tensile Stress)

The tensile stress value (CT, unit: MPa) was calculated by measuring the stress distribution according to the stress profile calculation method disclosed in JP-A-2016-142600 and integrating the stress distribution over the thickness.

### (Length)

As for the length of the glass sheet, the longitudinal length of the glass sheet having the dimension described below was measured using a digital caliper manufactured by Mitsutoyo Corporation.

### (Surface Damage)

The surface damage was distinguished by whether the damage, etc. is determined to be abnormal based on the standard determination or not when the appearance of glass is observed by setting the distance between glass and an eye of the judge to be 50 cm under illumination with an illuminance of 5,000 lux in a dark-room environment. Here, the damage that can be judged as a scratch having a width of 0.1 mm or as a scratch having a width of 0.05 mm to 0.1 mm and a length of 1 mm or more, in the environment described above, was determined to be abnormal.

### 2. Production of Chemically Strengthened Glass

### Example 1

### [Step (1)]

A glass sheet having a compressive stress layer formed in a surface layer thereof under the below-described ion exchange conditions was prepared using a glass sheet of 120 mm×60 mm×0.55 mm being produced by the float process and having the following composition (expressed in terms of mole percent based on oxides).

Glass A: SiO₂ 70%, Al₂O₃ 7.5%, Li₂O 8.0%, Na₂O 5.3%, K₂O 1.0%, MgO 7.0%, CaO 0.2%, and ZrO₂ 1.0%.

### (Ion Exchange Conditions)

As the first-stage ion exchange, the glass sheet described above was immersed for 1.5 hours in a molten salt bath of an inorganic salt composition containing 100 mass % of sodium nitrate kept at 450° C. Thereafter, the glass sheet was taken out from the bath, and the surface of the glass sheet was washed and dried.

As the second-stage ion exchange, the glass sheet after drying was immersed for 1.5 hours in a molten salt bath of an inorganic salt composition containing 100 mass % of potassium nitrate kept at 425° C. Thereafter, the glass sheet was taken out from the bath, and the surface of the glass sheet was washed and dried.

### [Step (2)]

The glass sheet prepared in step (1) was immersed for 30 hours in a molten salt bath of an inorganic salt composition containing 20 mass % of lithium nitrate and 80 mass % of sodium nitrate, kept at 400° C. Thereafter, the glass sheet was taken out from the bath, and the surface of the glass sheet was washed and dried. In the glass sheet after step (2), the compressive stress value of the glass surface was 100 [MPa] or less.

### [Polishing Step]

As a polishing slurry, a slurry having a specific gravity of 1.07 was prepared by dispersing cerium oxide having an average particle diameter (d50) of 1.2 μm in water. Using the obtained slurry and using a nonwoven fabric polishing pad having a Shore A hardness of 58° and a sinking amount at 100 g/cm² of 0.11 mm, both surfaces of the glass sheet were simultaneously polished each by 5 μm under the condition of a polishing pressure of 9.8 kPa.

### [Step (3)]

The glass sheet was subjected to ion exchange under the following conditions to obtain the chemically strengthened glass of Example 1.

### (Ion Exchange Conditions)

As the first-stage ion exchange, the glass sheet was immersed for 1.5 hours in a molten salt bath of an inorganic salt composition containing 100 mass % of sodium nitrate kept at 450° C. Thereafter, the glass sheet was taken out from the bath, and the surface of the glass sheet was washed and dried.

As the second-stage ion exchange, the glass sheet after drying was immersed for 1.5 hours in a molten salt bath of an inorganic salt composition containing 100 mass % of potassium nitrate kept at 425° C. Thereafter, the glass sheet was taken out from the bath, and the surface of the glass sheet was washed and dried.

### Examples 2 and 3

The chemically strengthened glasses of Examples 2 and 3 were prepared in the same manner as in Example 1 except that the ion exchange conditions of the step (2) were changed to the conditions shown in Table 1.

### Examples 4 and 5

The chemically strengthened glasses of Examples 4 and 5 were prepared in the same manner as in Example 1 except that the ion exchange conditions of the step (2) were changed to the conditions shown in Table 1. Specifically, in Examples 4 and 5, unlike Examples 1 to 3, ion exchange in the step (2) was conducted by immersing the glass sheet in an inorganic salt composition containing KNO₃ in a predetermined ratio.

### <Comparative Example 1

The chemically strengthened glass of Comparative Example 1 was prepared in the same manner as in Example 1 except that the step (2) was not conducted, and the glass sheet was subjected to polishing treatment and additional chemical strengthening treatment.

### Examples 6, 7 and 8

The chemically strengthened glasses of Examples 6, 7 and 8 were prepared in the same manner as in Example 1 except that the ion exchange conditions of the step (2) were changed to the conditions shown in Table 1. Specifically, in Examples 6, 7 and 8, unlike Examples 1 to 3, ion exchange in the step (2) was conducted by immersing the glass sheet in an inorganic salt composition containing KNO₃ in a predetermined ratio.

With respect to the chemically strengthened glasses obtained above, various evaluations were performed. The treatment conditions of the glass and the evaluation results are shown together in Table 1. In this evaluation, the evaluation was conducted by setting the standard for longitudinal length expansion ratio to be from 0.070 to 0.100%. Although the standard varies depending on the product specification, in Comparative Example 1, the expansion ratio was large, compared with Examples 1 to 8.

TABLE 1

| | | Exam- | Exam- | Exam- | Comp. | Exam- | Exam- | Exam- | Exam- | Exam- |
|---|---|---|---|---|---|---|---|---|---|---|
| | | ple 1 | ple 2 | ple 3 | Ex. 1 | ple 4 | ple 5 | ple 6 | ple 7 | ple 8 |
| Original | Glass | Glass A | | | | | | | | |
| sheet | composition | | | | | | | | | |
| | Length [mm] | 120.01 | | | | | | | | |
| Step (1) | Ion exchange | first stage: 100% NaNO₃, 450° C., 1.5 hours | | | | | | | | |
| | conditions | second stage: 100% KNO₃, 425° C., 1.5 hours | | | | | | | | |
| | CS [MPa] | 857 | | | | | | | | |
| | DOL [μm] | 110 | | | | | | | | |
| | CT [MPa] | 56 | | | | | | | | |
| | Length [mm] | 120.10 | | | | | | | | |
| | Expansion ratio [%] | 0.075 | | | | | | | | |
| | Surface damage | present | | | | | | | | |
| Step (2) | Ion exchange | 20% | 20% | 25% | not | 20% | 20% | 32% | 32% | 32% |
| | conditions | LiNO₃ + | LiNO₃ + | LiNO₃ + | conducted | LiNO₃ + | LiNO₃ + | LiNO₃ + | LiNO₃ + | LiNO₃ + |
| | | 80% | 80% | 75% | | 7.5% | 10% | 20% | 20% | 34% |
| | | NaNO₃, | NaNO₃, | NaNO₃, | | KNO₃ + | KNO₃ + | KNO₃ + | KNO₃ + | KNO₃ + |
| | | 400° C., | 400° C., | 400° C., | | 72.5% | 70% | 48% | 48% | 34% |
| | | 30 hours | 20 hours | 30 hours | | NaNO₃, | NaNO₃, | NaNO₃, | NaNO₃, | NaNO₃, |
| | | | | | | 400° C., | 400° C., | 400° C., | 460° C., | 400° C., |
| | | | | | | 30 hours | 30 hours | 30 hours | 6 hours | 30 hours |
| | Length [mm] | 120.03 | 120.04 | 120.02 | 120.10 | 120.01 | 120.01 | 120.02 | 120.01 | 120.03 |
| | Expansion ratio [%] | 0.017 | 0.025 | 0.008 | 0.075 | 0.000 | 0.000 | 0.008 | 0.000 | 0.017 |
| Polishing | Length [mm] | 120.02 | 120.03 | 120.01 | 120.10 | 119.99 | 119.99 | 120.00 | 119.99 | 120.02 |
| step | Expansion ratio [%] | 0.008 | 0.017 | 0.000 | 0.075 | −0.017 | −0.017 | −0.008 | −0.017 | 0.008 |
| Step (3) | Ion exchange | first stage: 100% NaNO₃, 450° C., 1.5 hours | | | | | | | | |
| | conditions | second stage: 100% KNO₃, 425° C., 1.5 hours | | | | | | | | |
| | CS [MPa] | 877 | 856 | 853 | 840 | 801 | 801 | 845 | 821 | 833 |
| | CT [MPa] | 56 | 53 | 57 | 59 | 54 | 59 | 54 | 55 | 58 |
| | Length [mm] | 120.10 | 120.13 | 120.12 | 120.15 | 120.10 | 120.10 | 120.12 | 120.10 | 120.13 |
| | Expansion ratio [%] | 0.075 | 0.100 | 0.092 | 0.117 | 0.075 | 0.075 | 0.092 | 0.075 | 0.100 |
| | Surface damage | none | none | none | none | none | none | none | none | none |

As shown in Table 1, in Examples 1 to 8, the compressive stress value of the compressive stress layer was effectively decreased by the first ion exchange step [step (2)] and expansion of the glass when increasing the compressive stress value of the compressive stress layer by the second ion exchange step [step (3)] could thereby be suppressed. In particular, a high-quality chemically strengthened glass having the same CS, DOL and dimension as those of the chemically strengthened glass prepared in the step (1) and being free of surface damage was obtained.

On the other hand, in Comparative Example 1, the first ion exchange step was not conducted and the compressive stress value of the compressive stress layer was increased by the second ion exchange step, as a result, the glass sheet was greatly expanded. Consequently, a chemically strengthened glass having the same dimension as that of the chemically strengthened glass prepared in the step (1) was not obtained.

It is understood from these results that, regarding a glass sheet having, in a surface layer thereof, a compressive stress layer, when the compressive stress value of the compressive stress layer is decreased through ion exchange and thereafter, the compressive stress value of the compressive stress layer is increased by again performing ion exchange, a chemically strengthened glass can be recycled with high quality.

The present application is based on Japanese patent application No. 2018-088231 filed on May 1, 2018 and Japanese patent application No. 2018-160835 filed on Aug. 29, 2018, and the contents of which are incorporated herein by reference.

According to the production method of a chemically strengthened glass of the present invention, a chemically strengthened glass can be recycled with high quality. The chemically strengthened glass obtained by the production method of a chemically strengthened glass of the present invention can be used for a cover glass of displays such as mobile phone, digital camera or touch panel display.

What is claimed is:

1. A method for producing a chemically strengthened glass, the method comprising the following steps (1) to (3) in this order:
(1) a glass sheet preparation step of preparing a glass sheet having, in a surface layer thereof, a compressive stress layer;
(2) a first ion exchange step of bringing the glass sheet into contact with an inorganic salt composition to perform ion exchange of at least one pair of ions so as to decrease a compressive stress value of the compressive stress layer; and
(3) a second ion exchange step of bringing the glass sheet into contact with an inorganic salt composition to perform ion exchange of at least one pair of ions so as to increase the compressive stress value of the compressive stress layer in the surface layer.

2. The method for producing a chemically strengthened glass according to claim 1, further comprising, between the first ion exchange step and the second ion exchange step, a polishing step of polishing a surface of the glass sheet.

3. The method for producing a chemically strengthened glass according to claim 2, wherein, in the polishing step, the surface of the glass sheet is polished by 1 μm or more.

4. The method for producing a chemically strengthened glass according to claim 3, wherein, in the polishing step, two main surfaces of the glass sheet opposing each other in a thickness direction are polished by the same removal amount.

5. The method for producing a chemically strengthened glass according to claim 1, further comprising, between the first ion exchange step and the second ion exchange step, an etching step of etching the surface of the glass sheet with a chemical solution containing hydrofluoric acid.

6. The method for producing a chemically strengthened glass according to claim 1, wherein a combination of ions in the pair of ions in the first ion exchange step is the same as a combination of ions in the pair of ions in the second ion exchange step.

7. The method for producing a chemically strengthened glass according to claim 6, wherein the combination of ions in the pair of ions is a combination of K ion and Na ion.

8. The method for producing a chemically strengthened glass according to claim 7, wherein, in the first ion exchange step, the glass sheet is brought into contact with an inorganic salt composition containing 50 mass % or more of NaNO₃.

9. The method for producing a chemically strengthened glass according to claim 7, wherein, in the second ion exchange step, the glass sheet is brought into contact with an inorganic salt composition containing 75 mass % or more of KNO₃.

10. The method for producing a chemically strengthened glass according to claim 1, wherein ion exchange of two pairs of ions is performed in the first ion exchange step, and ion exchange of two pairs of ions is performed in the second ion exchange step.

11. The method for producing a chemically strengthened glass according to claim 10, wherein combinations of ions in the two pairs of ions in the first ion exchange step is the same as combinations of ions in the two pairs of ions in the second ion exchange step.

12. The method for producing a chemically strengthened glass according to claim 11, wherein the combinations of ions in the two pairs of ions are a combination of K ion and Na ion and a combination of Na ion and Li ion.

13. The method for producing a chemically strengthened glass according to claim 12, wherein, in the first ion exchange step, the glass sheet is brought into contact with an inorganic salt composition containing 5 mass % or more of LiNO₃ and 50 mass % or more of NaNO₃.

14. The method for producing a chemically strengthened glass according to claim 12, wherein, in the first ion exchange step, the glass sheet is brought into contact with an inorganic salt composition containing 5 mass % or more of LiNO₃, 40 mass % or more of NaNO₃, and from 3 to 30 mass % of KNO₃.

15. The method for producing a chemically strengthened glass according to claim 12, wherein, in the second ion exchange step, the glass sheet is brought into contact with an inorganic salt composition containing 55 mass % or more of NaNO₃, and then brought into contact with an inorganic salt composition containing 75 mass % or more of KNO₃.

16. The method for producing a chemically strengthened glass according to claim 1, wherein the compressive stress value in the surface of the glass sheet is decreased to 100 MPa or less by the first ion exchange step.

17. The method for producing a chemically strengthened glass according to claim 1, wherein the glass sheet comprises a curved part having a radius of curvature of 100 mm or less in at least a part of the glass sheet.
